(19) United States
(12) Patent Application Publication
(10) Pub. No.: US 2025/0220568 A1
(43) Pub. Date: Jul. 3, 2025

(54) METHODS AND APPARATUSES FOR A CPAC BASED PSCELL OR SCG SWITCH PROCEDURE

(71) Applicant: LENOVO (BEIJING) LIMITED, Beijing (CN)

(72) Inventors: Congchi Zhang, Shanghai (CN); Lianhai Wu, Beijing (CN); Mingzeng Dai, Shanghai (CN); Le Yan, Shanghai (CN)

(21) Appl. No.: 18/852,747

(22) PCT Filed: Apr. 1, 2022
(86) PCT No.: PCT/CN2022/084751

§ 371 Date: Sep. 30, 2024

(51) Int. Cl. H04W 48/20; H04W 48/08

(52) U.S. Cl. CPC H04W 48/20; H04W 48/08

(57) ABSTRACT

Embodiments of the present application relate to methods and apparatuses for a conditional PSCell addition and change (CPAC) based primary cell of a secondary cell group (PSCell) or a secondary cell group (SCG) switch procedure. According to an embodiment of the present application, a user equipment (UE) includes a transceiver and a processor coupled to the transceiver; and the processor is configured: to receive a configuration related to an enhanced conditional primary cell of a second cell group (PSCell) change (eCPC) procedure via the transceiver from a network; and to start or stop the eCPC procedure in response to receiving the configuration related to the eCPC procedure.

### TECHNICAL FIELD

Embodiments of the present application generally relate to wireless communication technology, especially to methods and apparatuses for a conditional PSCell addition and change (CPAC) based primary cell of a secondary cell group (PSCell) or a secondary cell group (SCG) switch procedure.

### BACKGROUND

Next generation radio access network (NG-RAN) supports a multi-radio dual connectivity (MR-DC) operation. In a MR-DC scenario, a user equipment (UE) with multiple transceivers may be configured to utilize resources provided by two different nodes connected via non-ideal backhauls. One node may provide new radio (NR) access and the other one node may provide either evolved-universal mobile telecommunication system (UMTS) terrestrial radio access (UTRA) (E-UTRA) or NR access. One node may act as a master node (MN) and the other node may act as a secondary node (SN). The MN and SN are connected via a network interface (for example, Xn interface as specified in 3rd Generation Partnership Project (3GPP) standard documents), and at least the MN is connected to the core network.

According to agreements of 3GPP Release 17, a conditional PSCell addition (CPA) procedure and an inter-SN conditional PSCell change (CPC) procedure are supported. According to agreements of 3GPP standard documents, a conditional PSCell addition and change (CPAC) procedure is defined as a PSCell addition or change that is executed by a UE when execution condition(s) is met. A UE starts evaluating the execution condition(s) upon receiving CPAC configuration information, and stops evaluating the execution condition(s) once a PSCell addition procedure and/or a PSCell change procedure is triggered.

According to agreements of 3GPP Release 18, a CPAC based PSCell or SCG switch procedure is going to be supported. A CPAC based PSCell or SCG switch procedure may also be named as “a CPAC based PSCell/SCG switch procedure”, “a CPAC based fast PSCell switch procedure”, “a CPAC based fast SCG switch procedure” or “an enhanced CPAC procedure” or the like. Currently, in a 3GPP 5G system or network, details regarding a CPAC based PSCell/SCG switch procedure in a MR-DC scenario have not been discussed yet.

### SUMMARY

Some embodiments of the present application provide a user equipment (UE). The UE includes a transceiver and a processor coupled to the transceiver; and the processor is configured: to receive a configuration related to an enhanced conditional primary cell of a second cell group (PSCell) change (eCPC) procedure via the transceiver from a network; and to start or stop the eCPC procedure in response to receiving the configuration related to the eCPC procedure.

In some embodiments, the processor of the UE is configured to not release the configuration related to the eCPC procedure upon switching to a PSCell during the eCPC procedure.

In some embodiments, the processor of the UE is configured to transmit a first request to start or stop the eCPC procedure via the transceiver to the network.

In some embodiments, the first request is included in a UE assistance information message.

In some embodiments, the processor of the UE is configured: to receive a configuration related to a first timer via the transceiver from the network; to start the first timer upon transmitting the first request; and to transmit a second request to start or stop the eCPC procedure after an expiry of the first timer.

In some embodiments, to start the eCPC procedure, the processor of the UE is configured: to receive a first indicator to enable the eCPC procedure via the transceiver from the network; and to start the eCPC procedure in response to receiving both the configuration related to the eCPC procedure and the first indicator.

In some embodiments, in response to starting the eCPC procedure, the processor of the UE is configured: to measure a link quality of a candidate PSCell and to evaluate whether an execution condition of the candidate PSCell is fulfilled; and to execute a PSCell change to the candidate PSCell in response to the execution condition of the candidate PSCell being fulfilled.

In some embodiments, to stop the eCPC procedure, the processor of the UE is configured: to receive a second indicator to disable the eCPC procedure via the transceiver from the network; and to stop the eCPC procedure in response to receiving both the configuration related to the eCPC procedure and the second indicator.

In some embodiments, in response to receiving the second indicator, the processor of the UE is configured: to stop the eCPC procedure without releasing the configuration related to the eCPC procedure; or to stop the eCPC procedure and to release the configuration related to the eCPC procedure.

In some embodiments, in response to stopping the eCPC procedure, the processor of the UE is configured: to stop an on-going measurement of a link quality of a candidate PSCell and an on-going evaluation of whether an execution condition of the candidate PSCell is fulfilled; and to stop an on-going execution of a PSCell change to the candidate PSCell in response to the execution condition of the candidate PSCell being fulfilled.

In some embodiments, in response to stopping the eCPC procedure, the processor of the UE is configured: to stay in a connected state with a current serving PSCell of the UE; to keep a configuration associated with the current serving PSCell within the configuration related to the eCPC procedure; and to release at least one configuration associated with one or more other candidate PSCells within the configuration related to the eCPC procedure.

In some embodiments, at least one of the first indicator or the second indicator is received after transmitting the first request to the network.

In some embodiments, at least one of the first indicator or the second indicator is received via radio resource control (RRC) signaling, and the RRC signaling is generated by a master node (MN) or a secondary node (SN).

In some embodiments, in response to the RRC signaling being generated by the MN, the RRC signaling is sent over a master cell group (MCG) signaling radio bearer; or in response to the RRC signaling being generated by the SN: the RRC signaling is sent over a secondary cell group (SCG) signaling radio bearer; or the RRC signaling is encapsulated in a RRC message transmitted by the MN and sent over the MCG signaling radio bearer.

In some embodiments, to start or stop the eCPC procedure, the processor of the UE is configured: to determine whether to start or stop the eCPC procedure; and in response to receiving the configuration related to the eCPC procedure: to start the eCPC procedure in response to determining to start the eCPC procedure; or to stop the eCPC procedure in response to determining to stop the eCPC procedure.

In some embodiments, to stop the eCPC procedure, to determine whether to start or stop the eCPC procedure, the processor of the UE is configured: to switch to one PSCell during the eCPC procedure; and to determine whether the configuration related to the eCPC procedure includes one or more sets of execution conditions and radio configurations associated with one or more candidate PSCells when the one PSCell is a serving PSCell; and to stop the eCPC procedure in response to receiving the configuration related to the eCPC procedure and in response to determining that the configuration related to the eCPC procedure does not include the one or more sets of execution conditions and radio configurations associated with the one or more candidate PSCells when the one PSCell is the serving PSCell.

In some embodiments, in response to stopping the eCPC procedure, the processor of the UE is configured: to release the configuration related to the eCPC procedure; or to not release the configuration related to the eCPC procedure.

In some embodiments, in response to releasing the configuration related to the eCPC procedure, the processor of the UE is configured: to stay in a connected state with the one PSCell of the UE; and to keep a configuration associated with the one PSCell within the configuration related to the eCPC procedure; and to release at least one configuration associated with one or more other candidate PSCells within the configuration related to the eCPC procedure.

In some embodiments, in response to not releasing the configuration related to the eCPC procedure, the processor of the UE is configured: to receive a command to switch to one candidate PSCell via the transceiver from the network; and to resume the eCPC procedure to switch to the one candidate PSCell, in response to the configuration related to the eCPC procedure including one or more sets of execution conditions and radio configurations associated with one or more other candidate PSCells when the one candidate PSCell is a serving PSCell.

In some embodiments, to start or stop the eCPC procedure, the processor of the UE is configured: to receive a speed threshold value via the transceiver from the network; and in response to receiving the speed threshold value: to start the eCPC procedure in response to a speed of the UE being above the speed threshold value, or to stop the eCPC procedure in response to the speed of the UE being below the speed threshold value.

In some embodiments, the configuration related to the eCPC procedure includes at least one of: identifier (ID) information of a list of candidate PSCells; a radio configuration associated with a candidate PSCell within the list; a set of parameters related to a measurement configuration for the candidate PSCell; or a measurement identifier (MeasID) associated with the measurement configuration for the candidate PSCell.

In some embodiments, the set of parameters includes a set of execution conditions associated with the candidate PSCell, and an execution condition within the set of execution conditions includes at least one of: a set of criteria associated with the candidate PSCell; or a value range used for time to trigger (TTT) parameter related to the set of execution conditions.

In some embodiments, the processor of the UE is configured to switch to the candidate PSCell, in response to the set of criteria associated with the candidate PSCell being fulfilled for the value range used for TTT parameter.

In some embodiments, the processor of the UE is configured to determine whether to reset one or more sets of parameters related to the list of candidate PSCells, in response to: triggering to switch to the candidate PSCell; or successfully completing a random access to the candidate PSCell.

In some embodiments, the processor of the UE is configured to reset one or more TTT parameters related to one or more sets of execution conditions associated with all candidate PSCells within the list of candidate PSCells to be zero, in response to determining to reset the one or more sets of parameters related to the list of candidate PSCells.

In some embodiments, the processor of the UE is configured to determine whether to reset one or more sets of parameters related to all measurement configurations stored in the UE, in response to: triggering to switch to the candidate PSCell; or successfully completing a random access to the candidate PSCell.

In some embodiments, the processor of the UE is configured to reset one or more TTT parameters associated with the all measurement configurations to be zero, in response to determining to reset the one or more sets of parameters related to the all measurement configurations.

In some embodiments, the processor of the UE is configured: to receive a configuration related to a second timer via the transceiver from the network; and to start or resume the eCPC procedure after an expiry of the second timer.

In some embodiments, the configuration related to the second timer is received via radio resource control (RRC) signaling.

In some embodiments, the processor of the UE is configured to start the second timer, in response to: triggering to switch to a candidate PSCell; or successfully completing a random access to the candidate PSCell.

In some embodiments, in response to the second timer being running, the processor of the UE is configured: to keep an evaluation of whether an execution condition of a candidate PSCell is fulfilled; and to not trigger an execution of a PSCell change even if the execution condition of the candidate PSCell is fulfilled.

In some embodiments, in response to the second timer being running, the processor of the UE is configured to not evaluate whether an execution condition of a candidate PSCell is fulfilled.

In some embodiments, the processor of the UE is configured to stop the second timer, in response to at least one of: an occurrence of a SCG failure; or an expiry of a handover timer.

Some embodiments of the present application provide a method performed by a UE. The method includes: receiving a configuration related to an enhanced conditional primary cell of a second cell group (PSCell) change (eCPC) procedure from a network; and starting or stopping the eCPC procedure in response to receiving the configuration related to the eCPC procedure.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a UE.

Some embodiments of the present application also provide a network node (e.g., a BS). The network node includes a transceiver and a processor coupled to the transceiver; and the processor is configured to transmit a configuration related to an enhanced conditional primary cell of a second cell group (PSCell) change (eCPC) procedure via the transceiver to a user equipment (UE), wherein the eCPC procedure is started or stopped by the UE in response to the UE receiving the configuration related to the eCPC procedure.

In some embodiments, the configuration related to the eCPC procedure is not released by the UE upon the UE switching to a PSCell during the eCPC procedure.

In some embodiments, the configuration related to the eCPC procedure includes at least one of: identifier (ID) information of a list of candidate PSCells; a radio configuration associated with a candidate PSCell within the list; a set of parameters related to a measurement configuration for the candidate PSCell; or a measurement identifier (MeasID) associated with the measurement configuration for the candidate PSCell.

In some embodiments, the set of parameters includes a set of execution conditions associated with the candidate PSCell, and an execution condition within the set of execution conditions includes at least one of: a set of criteria associated with the candidate PSCell; or a value range used for time to trigger (TTT) parameter related to the set of execution conditions.

In some embodiments, the processor of the network node is configured to receive a first request to start or stop the eCPC procedure via the transceiver from the UE.

In some embodiments, the first request is included in a UE assistance information message.

In some embodiments, the processor of the network node is configured: to transmit a configuration related to a first timer via the transceiver to the UE; and to receive a second request to start or stop the eCPC procedure via the transceiver from the UE after an expiry of the first timer.

In some embodiments, the processor of the network node is configured: to transmit a first indicator to enable the eCPC procedure via the transceiver to the UE; or to transmit a second indicator to disable the eCPC procedure via the transceiver to the UE.

In some embodiments, at least one of the first indicator or the second indicator is transmitted after receiving the first request via the transceiver from the UE.

In some embodiments, at least one of the first indicator or the second indicator is transmitted via radio resource control (RRC) signaling, and the RRC signaling is generated by a master node (MN) or a secondary node (SN).

In some embodiments, in response to the RRC signaling being generated by the MN, the RRC signaling is sent over a master cell group (MCG) signaling radio bearer; or in response to the RRC signaling being generated by the SN: the RRC signaling is sent over a secondary cell group (SCG) signaling radio bearer; or the RRC signaling is encapsulated in a RRC message transmitted by the MN and sent over the MCG signaling radio bearer.

In some embodiments, the processor of the network node is configured to transmit a speed threshold value via the transceiver to the UE. The eCPC procedure is started in response to a speed of the UE being above the speed threshold value; or the eCPC procedure is stopped in response to the speed of the UE being below the speed threshold value.

In some embodiments, the processor of the network node is configured to transmit a configuration related to a second timer via the transceiver to the UE, and the eCPC procedure is started or resumed after an expiry of the second timer.

In some embodiments, the configuration related to the second timer is received via radio resource control (RRC) signaling.

In some embodiments, the second timer is started in response to: the UE triggering to switch to a candidate PSCell; or the UE successfully completing a random access to the candidate PSCell.

In some embodiments, the second timer is stopped in response to at least one of: an occurrence of a SCG failure; or an expiry of a handover timer.

Some embodiments of the present application provide a method performed by a network node. The method includes: transmitting a configuration related to an enhanced conditional primary cell of a second cell group (PSCell) change (eCPC) procedure to a user equipment (UE), wherein the eCPC procedure is started or stopped by the UE in response to the UE receiving the configuration related to the eCPC procedure.

Some embodiments of the present application provide an apparatus for wireless communications. The apparatus comprises: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement the abovementioned method performed by a network node.

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which advantages and features of the application can be obtained, a description of the application is rendered by reference to specific embodiments thereof, which are illustrated in the appended drawings. These drawings depict only example embodiments of the application and are not therefore to be considered limiting of its scope.

FIG. 1 illustrates a schematic diagram of a wireless communication system in accordance with some embodiments of the present application.

FIG. 2 illustrates an exemplary flowchart of receiving a configuration related to an eCPC procedure in accordance with some embodiments of the present application.

FIG. 3 illustrates an exemplary block diagram of an apparatus for an eCPC procedure in accordance with some embodiments of the present application.

FIG. 4 illustrates a further exemplary block diagram of an apparatus for an eCPC procedure in accordance with some embodiments of the present application.

### DETAILED DESCRIPTION

The detailed description of the appended drawings is intended as a description of preferred embodiments of the present application and is not intended to represent the only form in which the present application may be practiced. It should be understood that the same or equivalent functions may be accomplished by different embodiments that are intended to be encompassed within the spirit and scope of the present application.

Reference will now be made in detail to some embodiments of the present application, examples of which are illustrated in the accompanying drawings. To facilitate understanding, embodiments are provided under specific network architecture and new service scenarios, such as 3GPP 5G, 3GPP LTE Release 8 and so on. It is contemplated that along with developments of network architectures and new service scenarios, all embodiments in the present application are also applicable to similar technical problems; and moreover, the terminologies recited in the present application may change, which should not affect the principle of the present application.

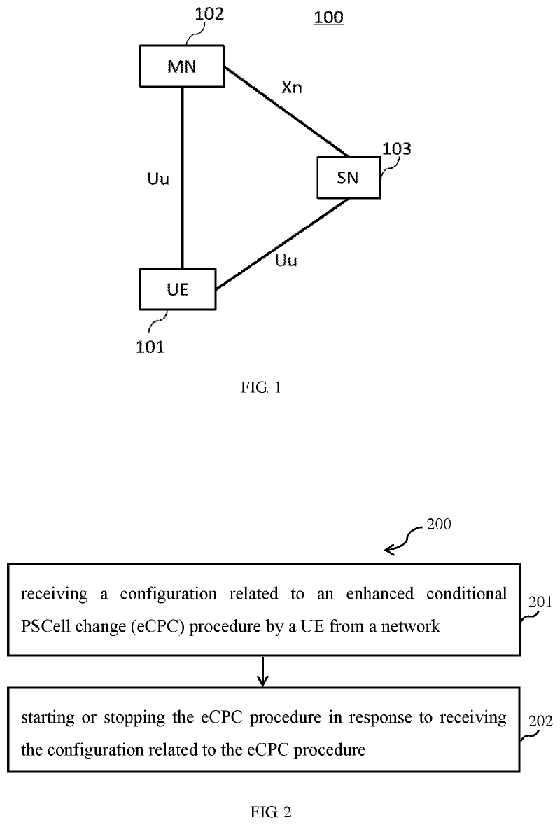

FIG. 1 illustrates a schematic diagram of a wireless communication system in accordance with some embodiments of the present application.

As shown in FIG. 1, the wireless communication system 100 may be a dual connectivity system 100, including at least one UE 101, at least one MN 102, and at least one SN 103. In particular, the dual connectivity system 100 in FIG. 1 includes one shown UE 101, one shown MN 102, and one shown SN 103 for illustrative purpose. Although a specific number of UEs 101, MNs 102, and SNs 103 are depicted in FIG. 1, it is contemplated that any number of UEs 101, MNs 102, and SNs 103 may be included in the wireless communication system 100.

Referring to FIG. 1, UE 101 may be connected to MN 102 and SN 103 via a network interface, for example, the Uu interface as specified in 3GPP standard documents. MN 102 and SN 103 may be connected with each other via a network interface, for example, the Xn interface as specified in 3GPP standard documents. MN 102 may be connected to the core network via a network interface (not shown in FIG. 1). UE 102 may be configured to utilize resources provided by MN 102 and SN 103 to perform data transmission.

MN 102 may refer to a radio access node that provides a control plane connection to the core network. In an embodiment of the present application, in the E-UTRA-NR Dual Connectivity (EN-DC) scenario, MN 102 may be an eNB. In another embodiment of the present application, in the next generation E-UTRA-NR Dual Connectivity (NGEN-DC) scenario, MN 102 may be an ng-eNB. In yet another embodiment of the present application, in the NR-E-UTRA Dual Connectivity (NE-DC) scenario or the NR-NR Dual Connectivity (NR-DC) scenario, MN 102 may be a gNB.

MN 102 may be associated with a master cell group (MCG). The MCG may refer to a group of serving cells associated with MN 102, and may include a primary cell (PCell) and optionally one or more secondary cells (SCells) of the MCG. The PCell may provide a control plane connection to UE 101.

SN 103 may refer to a radio access node without a control plane connection to the core network but providing additional resources to UE 101. In an embodiment of the present application, in the EN-DC scenario, SN 103 may be an en-gNB. In another embodiment of the present application, in the NE-DC scenario, SN 103 may be a ng-eNB. In yet another embodiment of the present application, in the NR-DC scenario or the NGEN-DC scenario, SN 103 may be a gNB.

SN 103 may be associated with a secondary cell group (SCG). The SCG may refer to a group of serving cells associated with SN 103, and may include a primary secondary cell (PSCell) and optionally one or more secondary cells (SCells). The PCell of the MCG and the PSCell of the SCG may also be referred to as a special cell (SpCell).

In some embodiments of the present application, UE 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. In some other embodiments of the present application, UE 101 may include a portable wireless communication device, a smart phone, a cellular telephone, a flip phone, a device having a subscriber identity module, a personal computer, a selective call receiving circuitry, or any other device that is capable of sending and receiving communication signals on a wireless network.

In some other embodiments of the present application, UE 101 may include wearable devices, such as smart watches, fitness bands, optical head-mounted displays, or the like. Moreover, UE 101 may be referred to as a subscriber unit, a mobile, a mobile station, a user, a terminal, a mobile terminal, a wireless terminal, a fixed terminal, a subscriber station, a user terminal, or a device, or described using other terminology used in the art.

According to 3GPP standard document TS38.331, seven measurement report events associated with a UE and their entering conditions and leaving conditions, i.e., Event A1, Event A3, Event A4, Event A5, Event A6, Event B1, and Event B2, are introduced as below.
(1) Event A1 (Serving becomes better than threshold)
(2) Event A3 (Neighbour becomes offset better than SpCell)
(3) Event A4 (Neighbour becomes better than threshold)
(4) Event A5 (SpCell becomes worse than threshold1 and neighbour becomes better than threshold2)
(5) Event A6 (Neighbour becomes offset better than SCell)
(6) Event B1 (Inter RAT neighbour becomes better than threshold)
(7) Event B2 (PCell becomes worse than threshold1 and inter RAT neighbour becomes better than threshold2)

Regarding a radio resource management (RRM) based condition, in NR system or EUTRAN system, 3GPP TS38.331 further defines CondEvent A3 and CondEvent A5 and their entering conditions and leaving conditions, respectively.
(1) CondEvent A3: Conditional reconfiguration candidate becomes amount of offset better than PCell/PSCell.
(2) CondEvent A5: PCell/PSCell becomes worse than one absolute threshold and Conditional reconfiguration candidate becomes better than another absolute threshold.

As defined in 3GPP TS38.331, radio resource control information elements includes an information element (IE) “TimeToTrigger (TTT)”. The IE TTT specifies the value range used for time to trigger parameter, which concerns the time during which specific criteria for the event (e.g., Event A1, Event A3, Event A4,Event A5, Event A6, Event B1, and Event B2, CondEvent A3 and/or CondEvent A5as described above) need to be met in order to trigger a measurement report. For example, value ms0 corresponds to 0 ms, value ms40 corresponds to 40 ms, and so on.

A specific usage case of TTT during an evaluation of execution conditions(s) for a measurement report triggering operation may be as follows. For instance, as defined in 3GPP TS38.331, for measurement report triggering, if reportType is set to eventTriggered and if the entry condition applicable for an event (e.g., any of Event A1, Event A3, Event A4, Event A5, Event A6, Event B1, and Event B2, CondEvent A3 and CondEvent A5), i.e., the event corresponding with eventId of the corresponding reportConfig within VarMeasConfig, is fulfilled for one or more applicable cells for all measurements after layer 3 filtering taken during time ToTrigger (TTT) defined for this event within VarMeasConfig, while VarMeasReportList does not include a measurement reporting entry for this measld (a first cell triggers the event).

Embodiments of the present application aim to specify details regarding a CPAC based PSCell/SCG switch procedure in 3GPP 5G system or the like. Embodiments of the present application study a specific scenario in a CPAC based PSCell/SCG switch procedure that after providing the conditional configuration(s) associated with candidate PSCells (e.g., similar to those for CPAC) to a UE, the UE may continue to perform PSCell/SCG switching according to the conditional configuration(s) and will not release the conditional configuration(s) upon switching to a new PSCell during the PSCell/SCG switch procedure. Embodiments of the present application define the abovementioned consecutive PSCell/SCG switch procedure as “an enhanced conditional PSCell change (eCPC) procedure”, which may also be named as “a consecutive conditional PSCell change (CCPC) procedure” or the like.

In the embodiments of the present application, in an eCPC procedure, after providing conditional configuration(s) associated with candidate PSCell(s) to a UE, the UE may perform a consecutive or enhanced PSCell/SCG switch procedure according to the conditional configuration(s) and will not release the conditional configuration(s) upon switching to a new PSCell during the consecutive or enhanced PSCell/SCG switch procedure. The non-released conditional configuration(s) may be reused by the UE in a subsequent switching operation to a PSCell in the eCPC procedure.

In the embodiments of the present application, in an eCPC procedure, a UE may switch between different PSCells according to conditional configuration(s) (e.g., consisting of execution condition(s) and/or radio configuration(s) for each candidate PSCell) configured by a network. When the eCPC procedure is started, a UE switches between candidate PSCells according to the execution condition(s) and does not release the conditional configuration(s) when switching between different PSCells. However, configuring an eCPC procedure cannot directly reuse what has been specified for a CPAC procedure.

More specifically, embodiments of the present application specify details regarding an eCPC procedure in a MR-DC scenario. Some embodiments of the present application specify a mechanism for a network to enable and disable an eCPC procedure after providing a configuration related to the eCPC procedure to a UE. Some embodiments of the present application specify a mechanism for a UE to start or resume an eCPC procedure after receiving a configuration related to the eCPC procedure from a network. Some embodiments of the present application specify a mechanism for a UE to stop or suspend an eCPC procedure after receiving a configuration related to the eCPC procedure from a network. Some embodiments of the present application specify a mechanism to avoid a too frequent PSCell change during an eCPC procedure, e.g., by resetting a time to trigger (TTT) parameter and/or adopting a timer for prohibiting a too frequent PSCell change. More details regarding the embodiments of the present application will be illustrated in the following text in combination with the appended drawings.

FIG. 2 illustrates an exemplary flowchart of receiving a configuration related to an eCPC procedure in accordance with some embodiments of the present application. The exemplary method 200 in the embodiments of FIG. 2 may be performed by a UE, e.g., UE 101 as shown in FIG. 1. Although described with respect to a UE, it should be understood that other devices may be configured to perform a method similar to that of FIG. 2.

In the exemplary method 200 as shown in FIG. 2, in operation 201, a UE receives a configuration related to an eCPC procedure from a network (e.g., MN 102 or SN 103 as shown in FIG. 1). In operation 202 as shown in FIG. 2, the UE starts or stops the eCPC procedure in response to receiving the configuration related to the eCPC procedure.

In some embodiments, the UE does not release the configuration related to the eCPC procedure upon switching to a PSCell during the eCPC procedure.

In some embodiments, in response to starting the eCPC procedure, the UE may measure a link quality of a candidate PSCell and evaluate whether an execution condition of the candidate PSCell is fulfilled, and may execute a PSCell change to the candidate PSCell in response to the execution condition of the candidate PSCell being fulfilled.

In some embodiments, in response to stopping the eCPC procedure, the UE may stop an on-going measurement of a link quality of a candidate PSCell and an on-going evaluation of whether an execution condition of the candidate PSCell is fulfilled, and may stop an on-going execution of a PSCell change to the candidate PSCell in response to the execution condition of the candidate PSCell being fulfilled.

In some embodiments, in response to stopping the eCPC procedure, the UE may stay in a connected state with a current serving PSCell of the UE, keep a configuration associated with the current serving PSCell within the configuration related to the eCPC procedure, and release at least one configuration associated with other candidate PSCell(s) within the configuration related to the eCPC procedure.

In some embodiments, the UE may transmit a request (e.g., request #1) to start or stop the eCPC procedure to the network. In an embodiment, the request (e.g., request #1) is included in a UE assistance information message.

In some embodiments, the UE may receive a configuration related to a timer (e.g., timer #1) from the network, start the timer upon transmitting the request (e.g., request #1), and transmit a further request (e.g., request #2) to start or stop the eCPC procedure after an expiry of the timer. The further request (e.g., request #2) may be included in a UE assistance information message.

In some embodiments, the UE may receive an indicator (e.g., indicator #1) to enable the eCPC procedure from the network, and start the eCPC procedure in response to receiving both the configuration related to the eCPC procedure and the indicator (e.g., indicator #1). For instance, the indicator may be received after the UE transmitting the request (e.g., request #1) or the further request (e.g., request #2) to the network.

In some embodiments, the UE may receive a further indicator (e.g., indicator #2) to disable the eCPC procedure from the network, and stop the eCPC procedure in response to receiving both the configuration related to the eCPC procedure and the further indicator. For instance, the further indicator (e.g., indicator #2) may be received after the UE transmitting the request (e.g., request #1) or the further request (e.g., request #2) to the network.

In some embodiments, in response to receiving the further indicator (e.g., indicator #2) to disable the eCPC procedure, the UE may stop the eCPC procedure without releasing the configuration related to the eCPC procedure. In some other embodiments, in response to receiving the further indicator (e.g., indicator #2), the UE may stop the eCPC procedure and release the configuration related to the eCPC procedure.

In some embodiments, the indicator (e.g., indicator #1) and/or the further indicator (e.g., indicator #2) may be received via radio resource control (RRC) signaling, and the RRC signaling may be generated by a MN or a SN. For instance, in a case that the RRC signaling is generated by the MN, the RRC signaling may be sent over a master cell group (MCG) signaling radio bearer. In a case that the RRC signaling is generated by the SN, the RRC signaling may be sent over a SCG signaling radio bearer or may be encapsulated in a RRC message transmitted by the MN and sent over the MCG signaling radio bearer.

In an embodiment of the exemplary method 200 (named as Embodiment 1 for simplicity), assuming that the UE is configured with a configuration related to the eCPC procedure, the UE will start the eCPC procedure (e.g., start evaluating the candidate PSCells) only if the UE receives signaling from the network to enable the eCPC procedure (e.g., indicator #1). The UE will stop the eCPC procedure if the UE receives further signaling from the network to disable the eCPC procedure (e.g., indicator #2). That is, in Embodiment 1, whether to start/resume the eCPC procedure or whether to stop/suspend the eCPC procedure depends upon the signaling from the network.

In Embodiment 1, the signaling from the network to enable or disable the eCPC procedure can be RRC signaling generated by a MN or a SN. If it is a MN generated RRC signaling to enable or disable the eCPC procedure, it may be sent over a MCG signaling radio bearer. If it is a SN generated RRC signaling to enable or disable the eCPC procedure, it may be sent over a SCG signaling radio bearer, or encapsulated in a MN RRC message and sent over a MCG signaling radio bearer.

In Embodiment 1, when the UE receives the RRC signaling from the network to disable the eCPC procedure, in one example, the UE stops the on-going eCPC procedure without releasing the configuration related to the eCPC procedure; and in another example, the UE stops the on-going eCPC procedure and releases the configuration related to the eCPC procedure. When the UE stops the on-going eCPC procedure, the UE may stay in a connected state with the current serving PSCell and keep the configuration related to the current serving PSCell (in other words, the UE releases configurations(s) related to all other candidate PSCell(s)).

In Embodiment 1, the UE may indicate to the network if the UE prefers to start or stop the eCPC procedure. The preference of the UE can be indicated via UE assistance information. For instance, if the UE wants to stop the on-going eCPC procedure due to a power saving reason, the UE generates a UE Assistance Information RRC message (e.g., request #1) including an indicator indicating its preference to stop the current eCPC procedure. The UE will stop the current eCPC procedure only if it receives a clear command (e.g., indicator #2) from the network to stop the current eCPC procedure.

In Embodiment 1, the UE may be configured with a prohibit timer (e.g., timer #1). For example, after sending the preference to stop the current eCPC procedure in the UE Assistance Information RRC message (e.g., request #1), the prohibit timer will be started. The UE is not allowed to send an indicator indicating its preference to start or stop the current eCPC procedure again (e.g., request #2) before an expiry of the prohibit timer.

In some embodiments of the exemplary method 200, the UE may determine whether to start or stop the eCPC procedure. In response to receiving the configuration related to the eCPC procedure, the UE may start the eCPC procedure in response to determining to start the eCPC procedure, or stop the eCPC procedure in response to determining to stop the eCPC procedure.

In some embodiments, the UE may switch to one PSCell during the eCPC procedure, and determine whether the configuration related to the eCPC procedure includes one or more sets of execution conditions and radio configurations associated with one or more candidate PSCells when the one PSCell is a serving PSCell. The UE may stop the eCPC procedure, in response to receiving the configuration related to the eCPC procedure and in response to determining that “the configuration related to the eCPC procedure does not include the one or more sets of execution conditions and radio configurations associated with the one or more candidate PSCells when the one PSCell is the serving PSCell”.

In some embodiments, in response to stopping the eCPC procedure, the UE may release the configuration related to the eCPC procedure. In an embodiment, in response to releasing the configuration related to the eCPC procedure, the UE may stay in a connected state with the one PSCell of the UE; and keep a configuration associated with the one PSCell within the configuration related to the eCPC procedure; and release at least one configuration associated with one or more other candidate PSCells within the configuration related to the eCPC procedure.

In some other embodiments, in response to stopping the eCPC procedure, the UE may not release the configuration related to the eCPC procedure. In an embodiment, in response to not releasing the configuration related to the eCPC procedure, the UE may receive a command to switch to one candidate PSCell from the network, and resume the eCPC procedure to switch to the one candidate PSCell in response to the configuration related to the eCPC procedure including one or more sets of execution conditions and radio configurations associated with one or more other candidate PSCells when the one candidate PSCell is a serving PSCell.

In some embodiments, the UE may receive a speed threshold value from the network. The UE may start the eCPC procedure in a case that a speed of the UE is above the speed threshold value. The UE may stop the eCPC procedure in a case that the speed of the UE is below the speed threshold value.

In an embodiment of the exemplary method 200 (named as Embodiment 2for simplicity), after the UE receives the configuration related to the eCPC procedure, the UE will determine whether to start/resume the eCPC procedure or whether to stop/suspend the eCPC procedure by the UE itself. That is, in Embodiment 2, whether to start/resume the eCPC procedure or whether to stop/suspend the eCPC procedure depends upon the UE's determination.

In Embodiment 2, assuming that the eCPC procedure is running, if the UE switches to one PSCell, for which the network didn't configure any associated candidate PSCells and relevant conditional configurations, the UE will stop the eCPC procedure. For instance, the network may configure the UE with multiple sets of conditional configurations, and each set of conditional configurations may correspond to one case when a particular PSCell becomes a serving PSCell. For example, in a case that PSCell #2 and PSCell #3 are candidate PSCells when the UE is connected to PSCell #1, or in a further case that PSCell #3 is a candidate PSCell when the UE is connected to PSCell #2, if the network didn't configure any candidate PSCell for a scenario when PSCell #3 becomes the serving PSCell, after the UE switches to PSCell #3 during the eCPC procedure, the UE will stop the eCPC procedure (due to no candidate PSCell configured for PSCell #3 which is the serving PSCell of the UE).

In an example of Embodiment 2, upon stopping the eCPC procedure, the UE releases the stored configuration related to the eCPC procedure. When the UE stops the on-going eCPC procedure, the UE stays in a connected state with the current serving PSCell, and keeps the configuration related to the current serving PSCell while releasing configuration(s) related to all other candidate PSCell(s).

In a further example of Embodiment 2, upon stopping the eCPC procedure, the UE does not release the stored configuration related to the eCPC procedure. Later on, if the UE follows the network's command and switches to one serving PSCell that is configured with candidate PSCell(s) according to the stored configuration related to the eCPC procedure, the UE will start/resume the eCPC procedure. For instance, if the UE switches back to PSCell #2, since the UE does not release the stored configuration related to candidate PSCell(s) for PSCell #2 which is the serving PSCell of the UE, the UE will start/resume the eCPC procedure, such that the UE may switch to a candidate PSCell configured for PSCell #2 based on the non-released stored configuration.

In Embodiment 2, the UE may be configured with a speed threshold by the network, such that the UE will automatically start/resume the eCPC procedure if the UE's speed is above the speed threshold. Correspondingly, the UE will automatically stop/suspend the eCPC procedure if the UE's speed is below the speed threshold.

In some embodiments of the exemplary method 200, the configuration related to the eCPC procedure includes at least one of:
(1) ID information of a list of candidate PSCells;
(2) A radio configuration associated with a candidate PSCell within the list;
(3) A set of parameters related to a measurement configuration for the candidate PSCell. In an embodiment, the set of parameters includes a set of execution conditions associated with the candidate PSCell. An execution condition within the set of execution conditions may include at least one of: a set of criteria associated with the candidate PSCell; or a value range used for time to trigger (TTT) parameter related to the set of execution conditions. For example, the UE may switch to the candidate PSCell, in response to the set of criteria associated with the candidate PSCell being fulfilled for the value range used for TTT parameter.
(4) A measurement identifier (MeasID) associated with the measurement configuration for the candidate PSCell.

In some embodiments, the UE may determine whether to reset one or more sets of parameters related to the list of candidate PSCells, in response to: (1) triggering to switch to the candidate PSCell; or (2) successfully completing a random access to the candidate PSCell. In an embodiment, the UE may reset one or more TTT parameters related to one or more sets of execution conditions associated with all candidate PSCells within the list of candidate PSCells to be zero, in response to determining to reset the one or more sets of parameters related to the list of candidate PSCells.

In some embodiments, the UE may determine whether to reset one or more sets of parameters related to all measurement configurations stored in the UE, in response to: (1) triggering to switch to the candidate PSCell; or (2) successfully completing a random access to the candidate PSCell. In an embodiment, the UE may reset one or more TTT parameters associated with the all measurement configurations to be zero, in response to determining to reset the one or more sets of parameters related to the all measurement configurations.

In an embodiment of the exemplary method 200 (named as Embodiment 3for simplicity), the UE is connected to a source PSCell and is configured with a number of candidate PSCells for the eCPC procedure. Each within the number of candidate PSCells is associated with an execution condition (e.g., the quality of one candidate PSCell is better than a threshold for TimeToTrigger duration) identified by a measurement identity (MeasID) variable. Each MeasID represents a measurement configuration with a TTT parameter. The UE will switch to a candidate PSCell if the execution condition is fulfilled for the TTT duration. A TTT parameter concerns a time duration during which specific criteria need to be met in order to trigger the execution of PSCell change associated with the eCPC procedure.

Embodiment 3 assumes that the UE is connected to a source PSCell and is configured with multiple candidate PSCells and each candidate PSCell is associated with a measurement configuration for the eCPC procedure. Upon switching to another PSCell is triggered or executed successfully, the UE will determine whether to reset parameter(s) (e.g., (re-)setting TTT to be zero) related to the measurement configuration(s) associated with one or multiple candidate PSCells.

In Embodiment 3, in one case, when the eCPC procedure is triggered and the UE switches from a source PSCell to a candidate PSCell successfully (e.g., a random access to the new PSCell succeeds), the UE resets parameter(s) (e.g., (re-)setting TTT to be zero) related to the measurement configuration(s) for the multiple candidate PSCells that have been previously configured. For example, the UE is currently connected to PSCell #1, and is configured with candidate PSCell #2 and PSCell #3. PSCell #2 is associated with MeasID #2, which is further related to TTT #2. PSCell #3 is associated with MeasID #3, which is further related to TTT #3. Only the execution condition indicated by MeasID #2 or MeasID #3 is fulfilled for a period of TTT #2 or TTT #3, the UE will switch to PSCell #2 or PSCell #3. When the UE switches from PSCell #1 to PSCell #2 or PSCell #3 successfully, the UE resets TTT #2 related to MeasID #2 and TTT #3 related to MeasID #3 to be zero.

In Embodiment 3, in a further case, when the eCPC procedure is triggered, the UE resets parameters (e.g., (re-)setting TTT to be zero) related to the measurement configurations for the candidate PSCells once the eCPC procedure is executed, no matter whether the switch is successful or not.

In Embodiment 3, in another case, when the eCPC procedure is triggered and the UE switches from a source PSCell to a candidate PSCell successfully, the UE resets parameters (e.g., (re-)setting TTT to be zero) related to all measurement configurations (identified by MeasIDs) stored in the UE.

In Embodiment 3, in yet another case, when the eCPC procedure is triggered, the UE resets parameters (e.g., (re-)setting TTT to be zero) related to all measurement configurations (identified by MeasIDs) stored in the UE, no matter whether the switch is successful or not.

In some embodiments of the exemplary method 200, the UE may receive a configuration related to a further timer (e.g., timer #2) from the network, and start or resume the eCPC procedure after an expiry of the second timer. In an embodiment, the configuration related to the further timer is received via RRC signaling.

In an embodiment, the UE may start the further timer (e.g., timer #2) in response to: (1) triggering to switch to a candidate PSCell; or (2) successfully completing a random access to the candidate PSCell. In an embodiment, the UE may stop the further timer (e.g., timer #2), in response to an occurrence of a SCG failure and/or an expiry of a handover timer (e.g., T304).

In an embodiment, in a case that the further timer (e.g., timer #2) is running, the UE may keep an evaluation of whether an execution condition of a candidate PSCell is fulfilled, but not trigger an execution of a PSCell change even if the execution condition of the candidate PSCell is fulfilled. In another embodiment, in a case that the further timer (e.g., timer #2) is running, the UE may not evaluate whether an execution condition of a candidate PSCell is fulfilled.

In an embodiment of the exemplary method 200 (named as Embodiment 4for simplicity), the UE is configured by the network a prohibit timer (e.g., timer #2) via RRC signaling for the eCPC procedure, so that the UE will not execute the PSCell change when the prohibit timer is running. In an example, the prohibit timer is started once the UE switches to a candidate PSCell successfully. In a further example, the prohibit timer is started once the switch to a candidate PSCell is executed, no matter whether the switch is successful or not.

In Embodiment 4, in an example, when the prohibit timer is running, the UE will keep evaluating candidate PSCells, but will not execute the PSCell change even if the execution condition is fulfilled. In a further example, when the prohibit timer is running, the UE will not evaluate the candidate PSCells.

In Embodiment 4, when the prohibit timer is running, in case of an occurrence of a SCG failure and/or an expiry of a handover timer (e.g., T304), the UE stops the prohibit timer.

It should be appreciated by persons skilled in the art that the sequence of the operations in exemplary procedure 200 may be changed and some of the operations in exemplary procedure 200 may be eliminated or modified, without departing from the spirit and scope of the disclosure. Details described in all other embodiments of the present application (for example, details regarding an eCPC procedure in a MR-DC scenario) are applicable for the embodiments of FIG. 2. Moreover, details described in the embodiments of FIG. 2 are applicable for all the embodiments of FIGS. 1, 3, and 4.

In addition, some embodiments of the present application provide an exemplary flowchart of a network node for transmitting a configuration related to an eCPC procedure in accordance with some embodiments of the present application, which may be performed by a network node, e.g., a BS (e.g., MN 102 or SN 103 as shown in FIG. 1). Although described with respect to a network node, it should be understood that other devices may be configured to perform a similar method.

It should be appreciated by persons skilled in the art that the sequence of the operations in this exemplary flowchart of a network node may be changed and some of the operations in this exemplary flowchart may be eliminated or modified, without departing from the spirit and scope of the disclosure. Details described in all other embodiments of the present application, e.g., in the embodiments of FIG. 2 (for example, all details regarding an eCPC procedure in a MR-DC scenario) are applicable for this exemplary flowchart. Moreover, details described in this exemplary flowchart are applicable for all the embodiments of FIGS. 1-4.

In particular, in this exemplary flowchart, a network node transmits a configuration related to an eCPC procedure to a UE (e.g., UE 101 as shown in FIG. 1). The eCPC procedure may be started or stopped by the UE in response to the UE receiving the configuration related to the eCPC procedure. In some embodiments, the configuration related to the eCPC procedure is not released by the UE upon the UE switching to a PSCell during the eCPC procedure.

In some embodiments, the configuration related to the eCPC procedure includes at least one of: ID information of a list of candidate PSCells; a radio configuration associated with a candidate PSCell within the list; a set of parameters related to a measurement configuration for the candidate PSCell; or a measurement identifier (MeasID) associated with the measurement configuration for the candidate PSCell. In an embodiment, the set of parameters includes a set of execution conditions associated with the candidate PSCell, and an execution condition within the set of execution conditions includes at least one of: a set of criteria associated with the candidate PSCell; or a value range used for TTT parameter related to the set of execution conditions.

In some embodiments, the network node may receive a request (e.g., request #1) to start or stop the eCPC procedure from the UE. For example, the request may be included in a UE assistance information message. In some embodiments, the network node may transmit a configuration related to a timer (e.g., timer #1) to the UE, and receive a further request (e.g., request #2) to start or stop the eCPC procedure from the UE after an expiry of the timer.

In some embodiments, the network node may transmit an indicator (e.g., indicator #1) to enable the eCPC procedure to the UE. In some other embodiments, the network node may transmit a further indicator (e.g., indicator #2) to disable the eCPC procedure to the UE. The indicator and/or the further indicator may be transmitted after the network node receiving the request (e.g., request #1) or the further request (e.g., request #2) from the UE. The indicator and/or the further indicator may be transmitted via RRC signaling generated by a MN or a SN. In some embodiments, in a case that the RRC signaling is generated by the MN, the RRC signaling is sent over a MCG signaling radio bearer. In a case that the RRC signaling is generated by the SN, the RRC signaling is sent over a SCG signaling radio bearer or is encapsulated in a RRC message transmitted by the MN and sent over the MCG signaling radio bearer.

In some embodiments, the network node may transmit a speed threshold value to the UE. The eCPC procedure may be started in a case that a speed of the UE is above the speed threshold value. The eCPC procedure may be stopped in a case that the speed of the UE is below the speed threshold value.

In some embodiments, the network node may transmit a configuration related to a further timer (e.g., timer #2) to the UE. The eCPC procedure may be started or resumed after an expiry of the further timer. The configuration related to the further timer may be received via RRC signaling. In an embodiment, the further timer (e.g., timer #2) may be started in response to: (1) the UE triggering to switch to a candidate PSCell; or (2) the UE successfully completing a random access to the candidate PSCell. In an embodiment, the further timer (e.g., timer #2) may be stopped in response an occurrence of a SCG failure and/or an expiry of a handover timer.

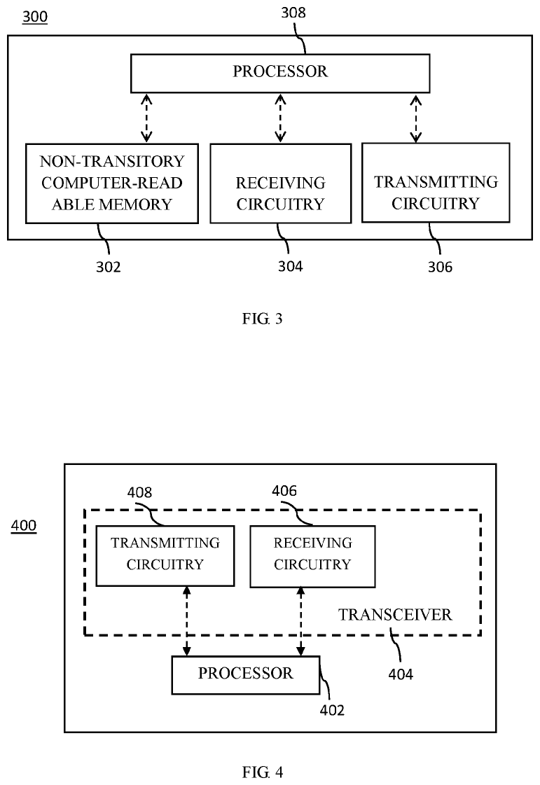

Some embodiments of the present application also provide a wireless communication apparatus for an eCPC procedure. For example, FIG. 3 illustrates an exemplary block diagram of an apparatus 300 for an eCPC procedure in accordance with some embodiments of the present application.

As shown in FIG. 3, the apparatus 300 may include at least one non-transitory computer-readable medium 302, at least one receiving circuitry 304, at least one transmitting circuitry 306, and at least one processor 308 coupled to the non-transitory computer-readable medium 302, the receiving circuitry 304 and the transmitting circuitry 306. The at least one processor 308 may be a CPU, a DSP, a microprocessor etc. The apparatus 300 may be a network node (e.g., a MN or a SN) or a UE configured to perform a method illustrated in the above or the like.

Although in this figure, elements such as the at least one processor 308, receiving circuitry 304, and transmitting circuitry 306 are described in the singular, the plural is contemplated unless a limitation to the singular is explicitly stated. In some embodiments of the present application, the receiving circuitry 304 and the transmitting circuitry 306 can be combined into a single device, such as a transceiver. In certain embodiments of the present application, the apparatus 300 may further include an input device, a memory, and/or other components.

In some embodiments of the present application, the non-transitory computer-readable medium 302 may have stored thereon computer-executable instructions to cause a processor to implement the methods with respect to a UE or a network node (e.g., a MN or a SN) as described or illustrated above. For example, the computer-executable instructions, when executed, cause the processor 308 interacting with receiving circuitry 304 and transmitting circuitry 306, so as to perform the steps with respect to a UE or a network node (e.g., a MN or a SN) as described or illustrated above.

FIG. 4 illustrates a further exemplary block diagram of an apparatus 400 for an eCPC procedure in accordance with some embodiments of the present application. Referring to FIG. 4, the apparatus 400, for example a BS or a UE, may include at least one processor 402 and at least one transceiver 404 coupled to the at least one processor 402. The transceiver 404 may include at least one separate receiving circuitry 406 and transmitting circuitry 408, or at least one integrated receiving circuitry 406 and transmitting circuitry 408. The at least one processor 402 may be a CPU, a DSP, a microprocessor etc.

According to some other embodiments of the present application, when the apparatus 400 is a UE, the processor 402 may be configured: to receive a configuration related to an eCPC procedure via the transceiver 404 from a network; and to start or stop the eCPC procedure in response to receiving the configuration related to the eCPC procedure.

According to some embodiments of the present application, when the apparatus 400 is a BS, the processor 402 is configured to transmit a configuration related to an eCPC procedure via the transceiver 404 to a UE, wherein the eCPC procedure is started or stopped by the UE in response to the UE receiving the configuration related to the eCPC procedure.

The method(s) of the present disclosure can be implemented on a programmed processor. However, controllers, flowcharts, and modules may also be implemented on a general purpose or special purpose computer, a programmed microprocessor or microcontroller and peripheral integrated circuit elements, an integrated circuit, a hardware electronic or logic circuit such as a discrete element circuit, a programmable logic device, or the like. In general, any device that has a finite state machine capable of implementing the flowcharts shown in the figures may be used to implement the processing functions of the present disclosure.

While this disclosure has been described with specific embodiments thereof, it is evident that many alternatives, modifications, and variations may be apparent to those skilled in the art. For example, various components of the embodiments may be interchanged, added, or substituted in the other embodiments. Also, all of the elements of each figure are not necessary for operation of the disclosed embodiments. For example, those having ordinary skills in the art would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including”.

1. A user equipment (UE), comprising:
at least one memory; and
at least one processor coupled with the at least one memory and configured to cause the UE to:
receive a configuration related to an enhanced conditional primary cell of a second cell group (PSCell) change (eCPC) procedure from a network; and
start or stop the eCPC procedure in response to receiving the configuration related to the eCPC procedure.

2. The UE of claim 1, wherein the at least one processor is configured to cause the UE to transmit a first request to start or stop the eCPC procedure to the network.

3. The UE of claim 2, wherein, to start the eCPC procedure, the at least one processor is configured to cause the UE to:
receive a first indicator to enable the eCPC procedure from the network; and
start the eCPC procedure in response to receiving both the configuration related to the eCPC procedure and the first indicator.

4. The UE of claim 2, wherein the at least one processor is configured to cause the UE to:
receive a configuration related to a first timer from the network;
start the first timer upon transmitting the first request; and
transmit a second request to start or stop the eCPC procedure after an expiry of the first timer.

5. The UE of claim 2, wherein, to stop the eCPC procedure, the at least one processor is configured to cause the UE to:
receive a second indicator to disable the eCPC procedure from the network; and
stop the eCPC procedure in response to receiving both the configuration related to the eCPC procedure and the second indicator.

6. The UE of claim 1, wherein, to start or stop the eCPC procedure, the at least one processor is configured to cause the UE to:
determine whether to start or stop the eCPC procedure; and
in response to receiving the configuration related to the eCPC procedure:
start the eCPC procedure in response to determining to start the eCPC procedure; or
stop the eCPC procedure in response to determining to stop the eCPC procedure.

7. The UE of claim 6, wherein, to stop the eCPC procedure, to determine whether to start or stop the eCPC procedure, the at least one processor is configured to cause the UE to:
switch to one PSCell during the eCPC procedure; and
determine whether the configuration related to the eCPC procedure includes: one or more sets of execution conditions and radio configurations associated with one or more candidate PSCells when the one PSCell is a serving PSCell; and
stop the eCPC procedure in response to receiving the configuration related to the eCPC procedure and in response to determining that the configuration related to the eCPC procedure does not include the one or more sets of execution conditions and radio configurations associated with the one or more candidate PSCells when the one PSCell is the serving PSCell.

8. The UE of claim 1, wherein the configuration related to the eCPC procedure includes at least one of:
identifier (ID) information of a list of candidate PSCells;
a radio configuration associated with a candidate PSCell within the list;
a set of parameters related to a measurement configuration for the candidate PSCell; or
a measurement identifier (MeasID) associated with the measurement configuration for the candidate PSCell.

9. The UE of claim 8, wherein the set of parameters includes a set of execution conditions associated with the candidate PSCell, and wherein an execution condition within the set of execution conditions includes at least one of:
a set of criteria associated with the candidate PSCell; or
a value range used for time to trigger (TTT) parameter related to the set of execution conditions.

10. The UE of claim 9, wherein the at least one processor is configured to cause the UE to switch to the candidate PSCell, in response to the set of criteria associated with the candidate PSCell being fulfilled for the value range used for TTT parameter.

11. The UE of claim 10, wherein the at least one processor is configured to cause the UE to determine whether to reset one or more sets of parameters related to the list of candidate PSCells, in response to:
triggering to switch to the candidate PSCell; or
successfully completing a random access to the candidate PSCell.

12. The UE of claim 11, wherein the at least one processor is configured to cause the UE to reset one or more TTT parameters related to one or more sets of execution conditions associated with all candidate PSCells within the list of candidate PSCells to be zero, in response to determining to reset the one or more sets of parameters related to the list of candidate PSCells.

13. The UE of claim 1, wherein the at least one processor is configured to cause the UE to:
receive a configuration related to a second timer from the network; and
start or resume the eCPC procedure after an expiry of the second timer.

14. An apparatus for performing a network function, the apparatus comprising:
at least one memory; and
at least one processor coupled with the at least one memory and configured to cause the apparatus to:
transmit a configuration related to an enhanced conditional primary cell of a second cell group (PSCell) change (eCPC) procedure to a user equipment (UE);
wherein the eCPC procedure is started or stopped by the UE in response to the UE receiving the configuration related to the eCPC procedure.

15. A method performed by a user equipment (UE), the method comprising:
receiving a configuration related to an enhanced conditional primary cell of a second cell group (PSCell) change (eCPC) procedure from a network; and
starting or stopping the eCPC procedure in response to receiving the configuration related to the eCPC procedure.

16. A processor for wireless communication, comprising:
at least one controller coupled with at least one memory and configured to cause the processor to:
receive a configuration related to an enhanced conditional primary cell of a second cell group (PSCell) change (eCPC) procedure from a network; and
start or stop the eCPC procedure in response to receiving the configuration related to the eCPC procedure.

17. The processor of claim 16, wherein the at least one controller is configured to cause the processor to transmit a first request to start or stop the eCPC procedure to the network.

18. The processor of claim 17, wherein, to start the eCPC procedure, the at least one controller is configured to cause the processor to:
receive a first indicator to enable the eCPC procedure from the network; and
start the eCPC procedure in response to receiving both the configuration related to the eCPC procedure and the first indicator.

19. The processor of claim 17, wherein the at least one controller is configured to cause the processor to:
receive a configuration related to a first timer from the network;
start the first timer upon transmitting the first request; and
transmit a second request to start or stop the eCPC procedure after an expiry of the first timer.

20. The processor of claim 17, wherein, to stop the eCPC procedure, the at least one controller is configured to cause the processor to:
receive a second indicator to disable the eCPC procedure from the network; and
stop the eCPC procedure in response to receiving both the configuration related to the eCPC procedure and the second indicator.
